(19) United States
(12) Patent Application Publication
(10) Pub. No.: US 2005/0083926 A1
(43) Pub. Date: Apr. 21, 2005

(54) Packet storage and retransmission over a secure connection

(76) Inventors: Robin Montague Mathews, Lowell, MA (US); Shantnu Sharma, Acton, MA (US)

Correspondence Address: FOGG AND ASSOCIATES, LLC, P.O. BOX 581339, MINNEAPOLIS, MN, 55458-1339, US

(21) Appl. No.: 10/686,086

(22) Filed: Oct. 15, 2003

(51) Int. Cl. H04L 12/56

(52) U.S. Cl. 370/389

(57) ABSTRACT

A method includes, when a packet is to be sent over a secured connection, determining if the secured connection is set up. The method also includes, when the secured connection is not set up, storing the packet and, after storing the packet, when the secure connection is set up, retrieving the packet and transmitting the packet over the secured connection.

### TECHNICAL FIELD

The following description relates to telecommunications in general and to the Internet Protocol Security Protocol in particular.

### BACKGROUND

The Internet Protocol (IP) Security Protocol (IPSEC) is a set of protocols developed by the Internet Engineering Task Force (IETF) IP Security Protocol Working Group to support secure exchange of packets between two nodes at the IP network layer. IPSEC provides many options for performing network encryption and authentication. In order for two nodes to exchange secured packets, the two nodes must agree on how they are going to identify themselves and process packets. This agreement is known as a security association (SA). A security association specifies information such as what authentication, encryption and/or compression algorithms are to be used, the shared session keys, the key lifetimes, the lifetime of the security association itself.

There are two types of security associations, the Internet Security Association Key Management Protocol (ISAKMP) security associations (also referred to here as “IKE security associations”) and IPSEC security associations. An IKE security association is bidirectional and provides a secure communication channel between the two parties that can be used to negotiate further communications in accordance with the IKE protocol. An IPSEC security association is unidirectional and is used for the actual communication between devices. For a two-way IPSEC connection between two nodes, there must be at least two IPSEC security associations, one in each direction. Hereinafter, references to a “security association” or “security associations” refer to IPSEC security security associations.

One feature typically included in an IPSEC and IKE implementations is known as “on-demand” negotiation. In such implementations, when a packet at a first node is to be transmitted to a second node, access control lists (or similar mechanisms) are checked to determine if the packet matches an IPSEC security policy set on the first node. If the packet matches an IPSEC security policy, the packet is transformed and transmitted to the second node in accordance with the IPSEC protocol.

Before the packet is transformed and transmitted in accordance with the IPSEC protocol, a check is made to determine if the necessary security associations are available for the IPSEC connection over which the packet is to be transmitted. If the necessary security associations are available, then the packet is transformed and transmitted to the second node in accordance with the IPSEC protocol over the IPSEC connection. If the necessary security associations are not available, the first node negotiates with the second node in accordance with the IKE protocol to set up the necessary security associations and the IPSEC connection. The necessary security associations will not be available, for example, if the IPSEC connections have not been set up in the first place or if previously set-up security associations have expired.

During the window of time when the security associations are not available and the IPSEC connection is not setup, the initial packet and any subsequent packets intended to be transmitted over that IPSEC connection are dropped until the security associations and the IPSEC connection are set up. Once the necessary security associations and the IPSEC connection have been set up, subsequent packets that are to be transmitted over the IPSEC connection are transformed and transmitted to the second node in accordance with the IPSEC protocol over the IPSEC connection.

In some applications, however, it is desirable to avoid dropping such packets when necessary security associations and the IPSEC connection are not available.

### SUMMARY

In one embodiment, a method includes, when a packet is to be sent over a secured connection, determining if the secured connection is set up. The method also includes, when the secured connection is not set up, storing the packet and, after storing the packet, when the secure connection is set up, retrieving the packet and transmitting the packet over the secured connection.

In another embodiment, a system includes a networking subsystem, a security subsystem, a negotiation subsystem, and a packet store. When the networking subsystem generates a packet that is to be transmitted over a secure connection, the networking subsystem determines if the secure connection is set up. When the secure connection is set up, the networking subsystem signals the negotiation subsystem to set up the secure connection and stores the packet in the packet store. After storing the packet, the security subsystem periodically determines whether the secure connection is set up. When the security subsystem determines that the secure connection is set up, the packet is retrieved from the packet store and the security subsystem transforms the packet and transmits the packet over the secure connection.

In another embodiment, a system includes a networking subsystem, an internet protocol security protocol subsystem, an internet key exchange subsystem, and a packet store. When the networking subsystem generates a packet that is to be transmitted over an internet protocol security protocol connection, the networking subsystem determines if a security association associated with the internet protocol security protocol connection exists. When the security association does not exist, the networking subsystem signals the internet key exchange subsystem to negotiate the security association and stores the packet in the packet store. After storing the packet, the internet protocol security protocol subsystem periodically determines whether the security association exists for the internet protocol security protocol connection. When the internet protocol security protocol subsystem determines that the security association exists for the internet protocol security protocol connection, the packet is retrieved from the packet store and the internet protocol security protocol subsystem transforms the packet and transmits the packet over the internet protocol security protocol connection in accordance with the internet protocol security protocol.

Another embodiment is a programmable-processor readable medium on which program instructions are stored. The program instructions are operable to cause a programmable processor to, when a packet is to be sent over a secured connection, determine if the secured connection is set up. The program instructions are further operable to cause the programmable processor to, when the secured connection is not set up, store the packet and, after storing the packet, when the secure connection is set up, retrieve the packet and transmitting the packet over the secured connection.

In another embodiment, a cable modem termination system includes a radio frequency interface that, when the cable modem termination system is coupled to a hybrid-fiber coaxial cable network, communicates with the hybrid-fiber coaxial cable network. The cable modem termination system further includes an second interface that, when the cable modem termination system is coupled to an upstream network, communicates with the upstream network. The cable modem termination system further includes a programmable processor coupled to the radio frequency interface and the second interface and memory coupled to the programmable processor. Program instructions are stored in the memory that, when executed on the programmable processor, cause the cable modem termination system to, when a packet is to be sent over an internet protocol security protocol connection, determine if a security association associated with the internet protocol security protocol connection exists. The program instructions, when executed on the programmable processor, cause the cable modem termination system to, when the security association does not exist, store the packet in a packet store and, after the packet is stored, periodically determine whether the security association exists for the internet protocol security protocol connection. The program instructions, when executed on the programmable processor, cause the cable modem termination system to, when the security association exists for the internet protocol security protocol connection, retrieve the packet from the packet store and transmit the packet over the internet protocol security protocol connection.

In another embodiment, a network interface module includes an external network interface that, when the network interface module is coupled to an external network, couples the network interface module to the external network. The network interface module further includes a backplane interface that, when the network interface module is coupled to a backplane, communicates with the backplane. The network interface module further includes a programmable processor coupled to the external network interface and the backplane interface, and memory coupled to the programmable processor. Program instructions are stored in the memory that, when executed on the programmable processor, cause the network interface module to, when a packet is to be sent over an internet protocol security protocol connection, determine if a security association associated with the internet protocol security protocol connection exists. The program instructions, when executed on the programmable processor, cause the network interface module to, when the security association does not exist, store the packet in a packet store, and, after the packet is stored, periodically determine whether the security association exists for the internet protocol security protocol connection. The program instructions, when executed on the programmable processor, cause the network interface module to, when the security association exists for the internet protocol security protocol connection, retrieve the packet from the packet store and transmit the packet over the internet protocol security protocol connection.

The details of one or more embodiments of the claimed invention are set forth in the accompanying drawings and the description below. Other features and advantages will become apparent from the description, the drawings, and the claims.

### DRAWINGS

FIGS. 1A through 1B show a high-level flow diagram of one embodiment of a method 100 of processing a packet that is to be transmitted over a secure connection.

FIG. 2 is a high-level block diagram of one embodiment of a system that includes functionality that implements the IPSEC protocol.

FIGS. 3A through 3B show a flow diagram of one embodiment of method of transmitting a packet.

FIGS. 4A through 4B show a flow diagram of one embodiment of a callback function.

FIG. 5 is one embodiment of a method of flushing packets from the queue.

FIG. 6A is a block diagram of one embodiment of a cable system 600 in which embodiments described here are implemented.

FIG. 6B is a block diagram of one embodiment of a cable modem termination system suitable for use in the cable system of FIG. 6A.

FIG. 6C is a block diagram of one embodiment of a network interface module suitable for use in the cable system of FIG. 6A.

Like reference numbers and designations in the various drawings indicate like elements.

### DETAILED DESCRIPTION

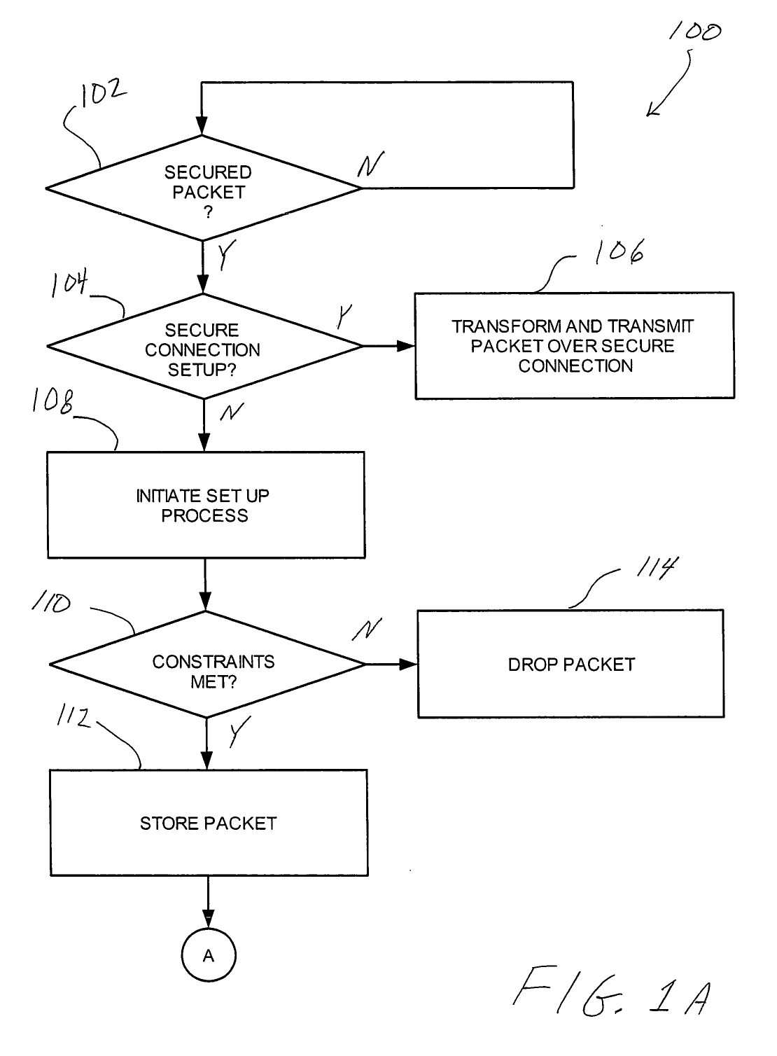

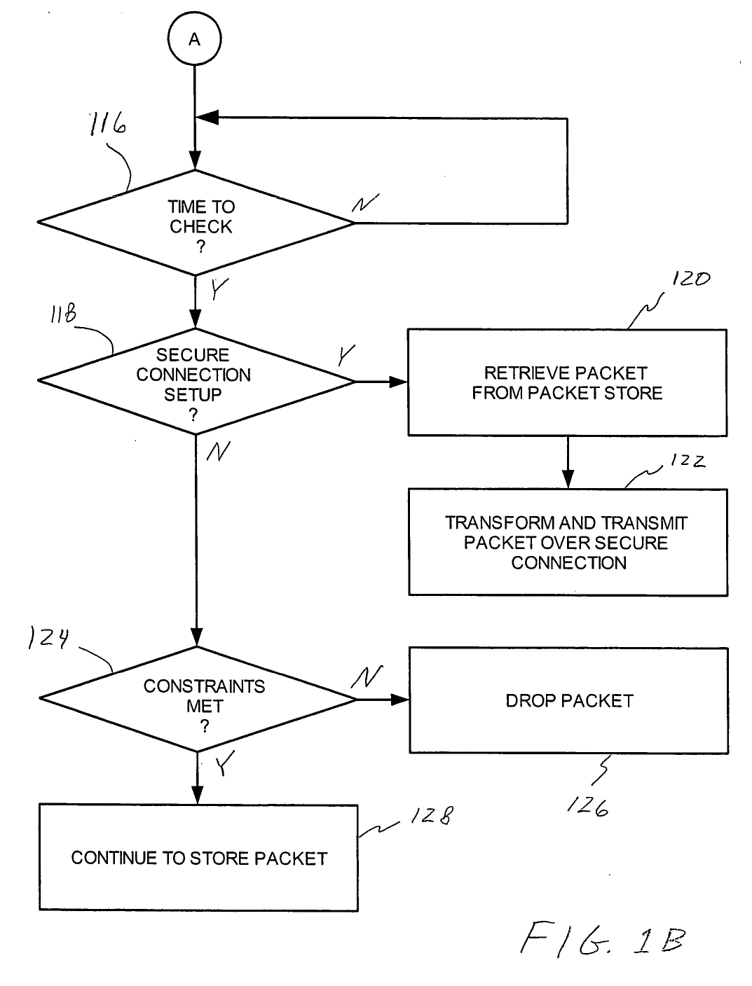

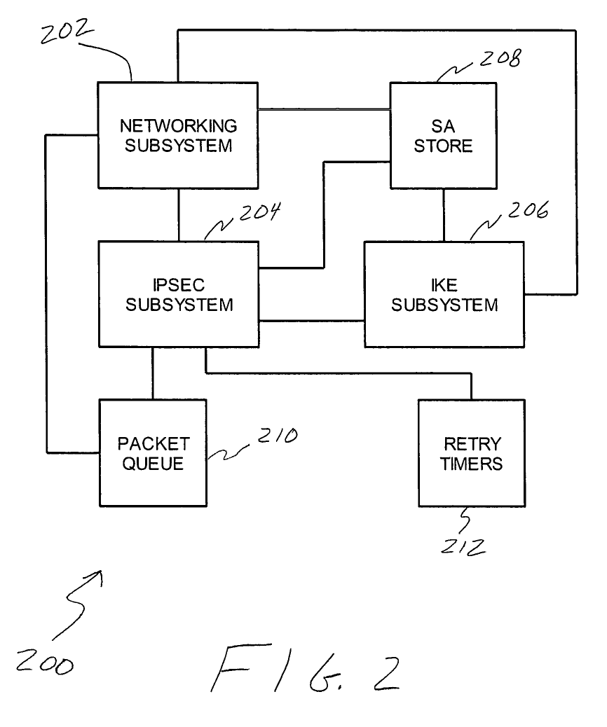

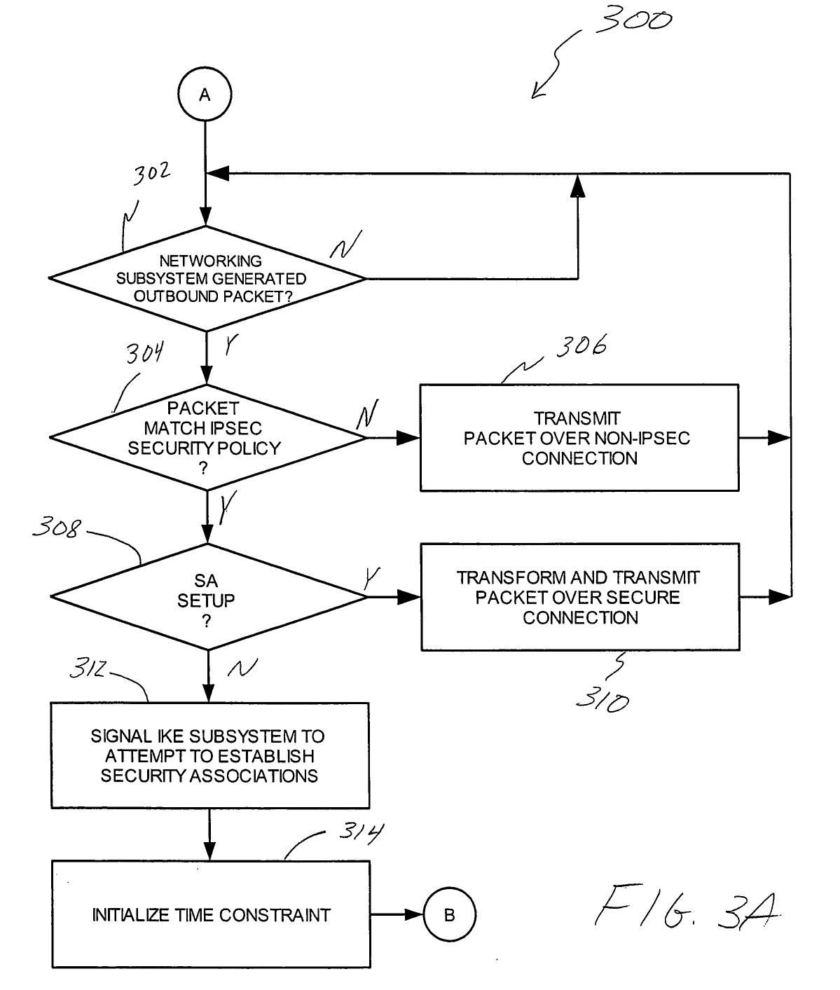

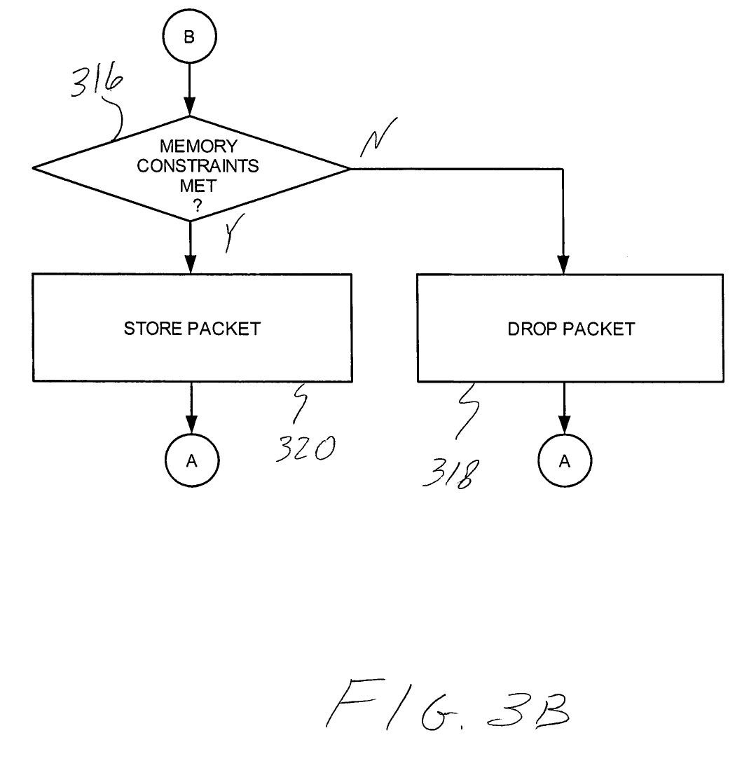

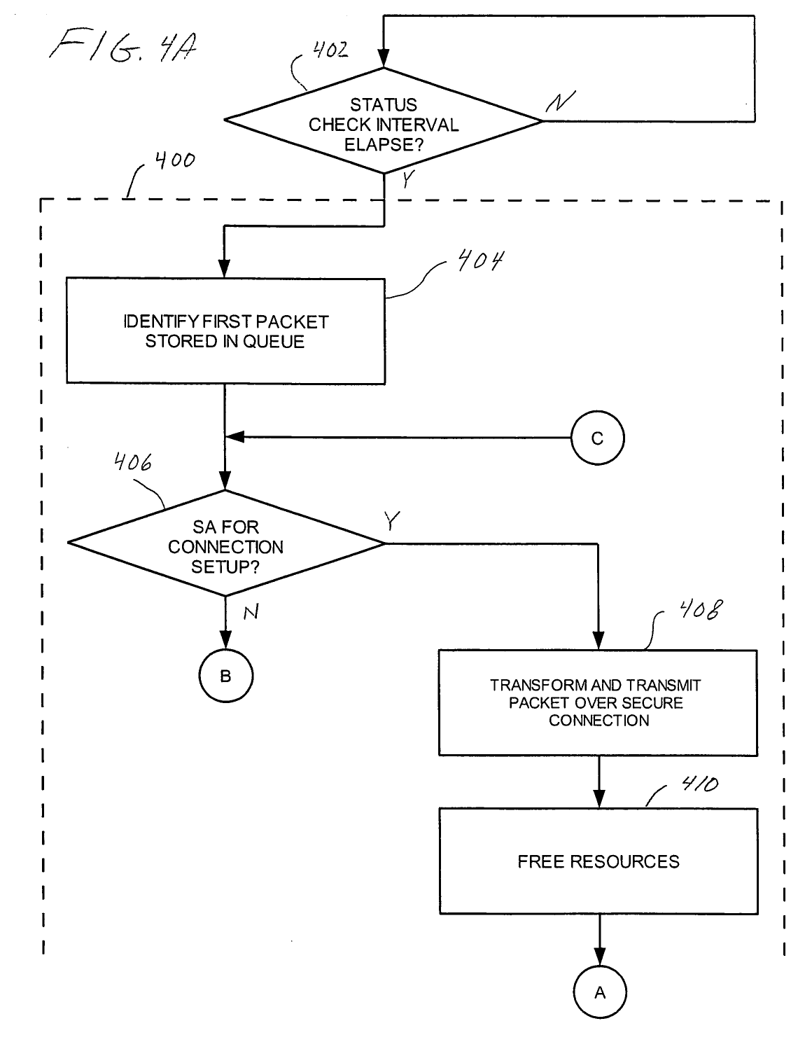

FIGS. 1A through 1B show a high-level flow diagram of one embodiment of a method 100 of processing a packet that is to be transmitted over a secure connection. In particular, embodiments of method 100 process a packet that is intended to be transmitted from a first node (also referred to here as a “source node” or a “transmitting node”) to a second node (also referred to here as a “destination node” or a “receiving node”) over a secure connection. In the embodiment shown in FIGS. 1A through 1B, the secure connection is an IPSEC connection. As noted above, each IPSEC connection between a transmitting node and a destination node has one or more security associations that specify various information used by the IPSEC protocol to exchange packets over the IPSEC connection.

In one implementation of such an embodiment, security associations are established using the IKE protocol. The process of negotiating the various parameters of one or more security association using the IKE protocol is referred to here as “setting up” the IPSEC connection and/or the security associations. While the IPSEC connection and the related security associations are being set up, packets cannot be transmitted over that IPSEC connection.

When a packet is to be sent over a secure connection (checked in block 102 shown in FIG. 1A), a determination is made as to whether the secure connection has been set up (checked in block 104). For example, in the embodiment shown in FIGS. 1A through 1B, the determination is made as to whether or not appropriate security associations exist for the IPSEC connection over which the packet is to be transmitted. The security associations will not be available, for example, if the IPSEC connections have not been set up in the first place or if previously set-up security associations have expired.

If the secure connection has been set up, the packet is transformed and transmitted over the secure connection (block 106). In the embodiment shown in FIGS. 1A through 1B, the packet is transformed and transmitted over an IPSEC connection in accordance with the IPSEC protocol. If, however, the secure connection has not been set up, the process of setting up the secure connection is initiated (block 108). For example, in one implementation, an IPSEC connection is set up using the IKE protocol to negotiate one or more security associations required for the IPSEC connection.

Instead of dropping the packet while the secure connection is being setup, the packet is stored. In the embodiment of method 100 shown in FIGS. 1A through 1B, one or more constraints control or limit some aspect related to storage of the packet while the secure connection is being setup. For example, in one embodiment, the constraints specify the maximum amount of time a packet can be stored, the maximum number of packets that can be stored at one time, and/or the maximum amount of memory that can be used for storing packets at any one time. These constraints are used so that packets are not stored too long thus destabilizing method 100. Also, the constraints are used so that the storage of packets and the related processing does not use an excessive amount of memory or processor time.

In the particular embodiment shown in FIGS. 1A through 1B, before the packet is stored, a determination is made as to whether the storage of the packet would meet one or more constraints related to the storage of packets (block 110). If storage of the packet would meet all such constraints, the packet is stored (block 112). If storage of the packet would not meet any such constraint, the packet is dropped (block 114).

As shown in FIG. 1B, periodically (checked in block 116) a determination is made as to whether the IPSEC connection has been set up (block 118). When the IPSEC connection has been successfully set up, the stored packet is retrieved from storage (block 120) and is transformed and transmitted over the IPSEC connection in accordance with the IPSEC protocol (block 122). If the IPSEC connection for the stored packet has not been set up, a determination is made as to whether the continued storage of the packet would meet one or more constraints related to the storage of packets (block 124). In one embodiment for example, this determination includes checking if the packet has been stored for an amount of time that exceeds the maximum time allowed for a packet to be stored. If the continued storage of the packet would not meet any such constraints, the packet is dropped (block 126). Otherwise, the packet continues to be stored (block 128).

With embodiments of method 100, the number of packets that are dropped while an IPSEC connection is being set up is reduced. This reduces the likelihood that a higher-level application or protocol will be adversely affected. For example where the higher-level application provides a voice-over-IP connection, embodiments of method 100 will reduce the likelihood that a call will be dropped due to the dropping of packets.

FIG. 2 is a high-level block diagram of one embodiment of a system 200 that includes functionality that implements the IPSEC protocol. The system 200 is suitable for implementing an embodiment of method 100 shown in FIGS. 1A through 1B. In one implementation of the system 200, the components of system 200 are implemented in software as one or more separate tasks or threads executing on one or more programmable processors. Other embodiments are implemented in other ways and using different hardware.

The system 200 includes a networking subsystem 202 that handles the core transport control protocol/internet protocol (TCP/IP) stack processing, an IPSEC subsystem 204 that implements the IPSEC protocols in order to provide security functionality (authentication, encryption, etc.), and an IKE subsystem 206 that implements the IKE protocol in order to negotiate security associations used by the IPSEC subsystem 204. In one implementation, the networking subsystem 202, the IPSEC subsystem 204, and the IKE subsystem 206 are each implemented using one or more separate tasks that are executed on one or more programmable processors. In such an implementation, the various tasks communicate with one another using some form of inter process communication (IPC).

In the embodiment of system 200 shown in FIG. 2, system 200 also includes a security association storage data structure 208 (also referred to here as the “security association store” 208). For example, in one implementation, the security association store 208 is implemented using a database. Other data structures are used in other implementations. Security associations that are negotiated by the IKE subsystem 206 for various IPSEC connections are stored in the security association store 208. Thereafter, the networking subsystem 202 and the IPSEC subsystem 204 are able to access the security associations stored in the security association store 208.

Also, the system 200 includes a retry packet queue 210. While an IPSEC connection and the associated security associations are being set up by the IKE subsystem 206, packets cannot be transmitted over that IPSEC connection. In the embodiment shown in FIG. 2, packets generated by the networking subsystem 202 for transmission over an IPSEC connection that has not been set up are stored in the retry packet queue 210. When the IPSEC connection is ultimately setup (that is, when the IKE subsystem 206 completes the negotiation process and sets up the one or more security associations for that IPSEC connection), the packets stored in the queue 210 are retrieved from the queue 210 and transmitted over the set-up IPSEC connection.

In one implementation, the retry packet queue 210 is implemented as a dynamic, doubly linked list in which each packet stored in the queue 210 is stored in an element of the doubly linked list. In such an implementation, each element of the doubly linked list includes a pointer or other reference to the next element (if any) in the queue 210 and a pointer or other reference to the previous element (if any) in the queue 210. Using such a doubly linked list to implement the queue 210 makes it easier to implement functions that check all the packets stored in the queue 110 at a given point in time. An example of one such function is a function that checks each packet stored in the queue 110 to see if that packet has been stored in the queue 110 for an amount of time that is longer than a specified maximum storage time. Such a function can easily determine the next element in the queue 210 (which contains the next packet stored in the queue 110) using the pointer to the next element in the queue 110.

In the embodiment shown in FIG. 2, the system 200 further includes one or more retry timers 212. One retry timer triggers the IPSEC subsystem 204 at periodic intervals to check if an IPSEC connection has been set up for each packet stored in the queue 210. The periodic interval after which the IPSEC subsystem 204 is triggered is referred to here as the “status check interval.” Also, the retry timers are used to trigger the IPSEC subsystem 204 at periodic intervals to check if each packet in the queue 210 should be removed from the queue 210 and dropped because one or more constraints have been exceeded. This second periodic interval is referred to here as the “constraint check interval.” For example, in one implementation, the constraints specify the maximum amount of time a packet can be stored in the queue 210′ (also referred to here as the “maximum storage time”), the maximum number of packets that can be stored in the queue 210 (also referred to here as the “maximum packet limit”), and/or the maximum amount of system memory that can be used by the queue 210 (also referred to here as the “maximum queue size”). In one embodiment, the maximum storage time is equal to 15 seconds, the maximum packet limit is 10, and the maximum queue size is 18600 bytes.

One embodiment of method 100 shown in FIGS. 3A, 3B, 4A, 4B and 5 is implemented using the system 200 of FIG. 2. The methods shown in FIGS. 3A, 3B, 4A, 4B and 5 process a packet that is intended to be transmitted from a transmitting node to a destination node. Some of the packets transmitted from the transmitting mode are transmitted over an IPSEC connection. The transmitting node, in such an embodiment, implements the system 200 of FIG. 2.

FIGS. 3A through 3B show a flow diagram of one embodiment of method 300 of transmitting a packet. When an outbound packet is generated by the networking subsystem 202 of the transmitting node (checked in block 302 shown in FIG. 3A), the networking subsystem 202 checks if the packet matches an IPSEC security policy that is set for the transmitting node (block 304). For example, in one such implementation, access control lists are maintained by the transmitting node that indicate, for example, that transmissions intended for particular destination nodes are to be secured using the IPSEC protocol.

If the packet does not match an IPSEC security policy set for the transmitting node, the packet is transmitted to the destination node by the networking subsystem 202 without using the IPSEC protocol (block 306). If the packet does match a security policy set for the transmitting node, the networking subsystem 202 of the transmitting node checks if the IPSEC connection over which the packet is to be transmitted to the destination node has been set up. Specifically, the networking subsystem 102 checks if the security associations for that IPSEC connection exist (block 308). If the security associations exist for the IPSEC connection, the packet is passed to the IPSEC subsystem 204 for transformation and transmission in accordance with the IPSEC protocol (block 310).

If the security associations do not exist for the IPSEC connection, the networking subsystem 202 signals the IKE subsystem 206 to negotiate with the destination node to attempt to establish the necessary security associations for the IPSEC connection (block 312). As noted above, while the IKE subsystem 206 negotiates security associations for the IPSEC connection, the packet cannot be transmitted over that connection. Instead of being dropped, the packet is stored in queue 210.

In the embodiment shown in FIGS. 3A through 3B, before the packet is actually stored in the queue 210, the networking subsystem 202 initializes a time constraint for the packet (block 314). In the embodiment shown in FIGS. 3A, 3B, 4A, 4B and 5, a callback function is executed periodically by the IPSEC subsystem 202 to check, for each packet stored in the queue 210, if the security associations have been set up for the IPSEC connection over which that packet is to be transmitted. The callback function is executed after successive status check intervals elapse. In such an embodiment, initializing a time constraint for each packet involves allocating one or more data structures that are used by the callback function to keep track of the status of that packet and populating each data structure with a suitable initial value. For example in one implementation of such an embodiment, one data structure includes a variable (for example, a counter) that is used to keep track of how long the packet has been stored in the queue 210. In one such implementation, such a data structure is stored in the queue 210 along with the packet.

Also, the networking subsystem 202 checks if a memory constraint established for the queue 210 will still be satisfied by storing the packet in the queue 210 (block 316 as shown in FIG. 3B). In one implementation, the memory constraints include the maximum packet limit and the maximum queue size. If storing the packet in the queue 210 would result in the maximum packet limit or the maximum queue size being exceeded, the packet is not stored in the queue 210 and is dropped (block 318). If storing the packet in the queue 210 would not result in the maximum packet limit or the maximum queue size being exceeded, the packet is stored in the queue 210 (block 320).

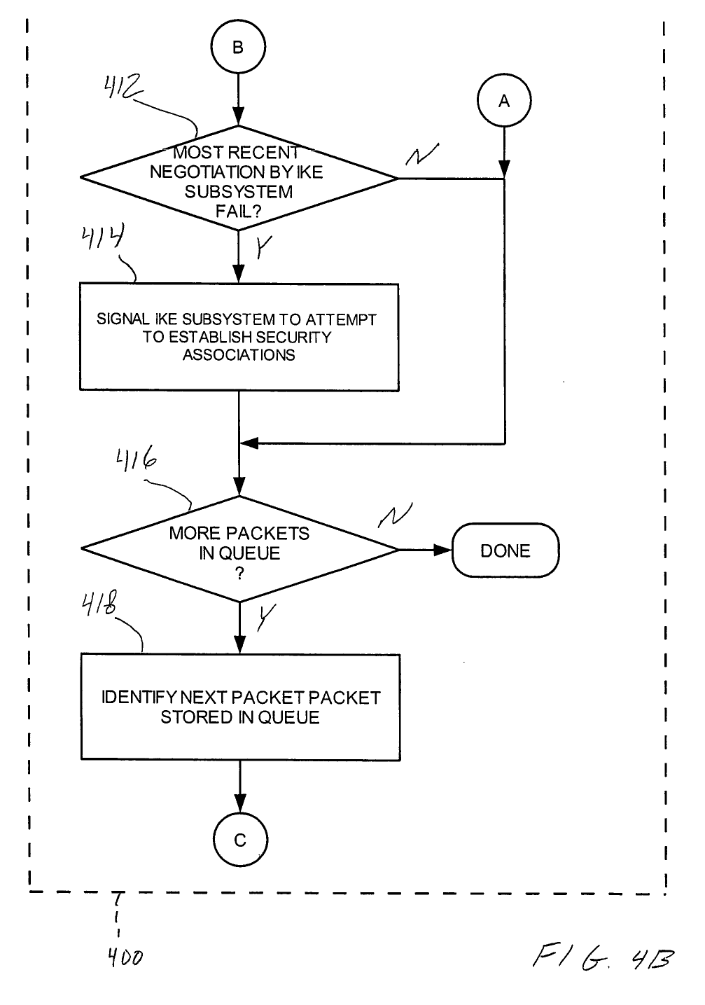

FIGS. 4A through 4B show a flow diagram of one embodiment of a callback function 400. In the embodiment shown in FIGS. 4A through 4B, callback function 400 is executed by the IPSEC subsystem 204 after each time the status check interval elapses. When the retry timer 212 indicates that a status check interval has elapsed (checked in block 402 shown in FIG. 4A), the callback function 400 is executed. Callback function 400, when executed, identifies a first packet stored in the queue 210 (block 404). For example, in one implementation, there is a function, that when executed, returns a pointer or other reference to a first packet stored in the queue 210 (or the queue element in which the first packet is stored).

Next, the callback function 400 determines if the security associations have been established yet for the IPSEC connection over which the first packet is to be transmitted (checked in block 406). The callback function 400 communicates with the IKE subsystem 206 to make this determination. If the security associations for the first packet have been set up, then the first packet is transformed and transmitted over the IPSEC connection by the IPSEC subsystem 204 in accordance with IPSEC protocol (block 408) and the resources used to store the first packet in the queue 210 are freed up (block 410).

If the security associations for the first packet have not been set up, the IPSEC subsystem 204 determines if the most recent attempt by the IKE subsystem 206 to establish the security associations for the first packet has failed (block 412 shown in FIG. 4B). That is, the IPSEC subsystem 204 determines if the negotiation process performed by the IKE subsystem 206 has finished but was unsuccessful in setting up the security associations for the IPSEC connection over which the first packet is transmitted. If it is determined that the most recent attempt by the IKE subsystem 206 to establish the security associations for the first packet has failed, the IPSEC subsystem 204 signals the IKE subsystem 206 to make another attempt at negotiating with the destination node to attempt to establish the necessary security associations for the IPSEC connection (block 414).

If there is a another packet in the queue 210 (checked in block 416), then the call back function 400 identifies the next packet in the queue 210 (block 418). Then the call back function 400 is repeated for that next packet. Otherwise, the call back function 400 terminates when all the packets store in queue 210 have been checked. As shown in FIGS. 4A through 4B, the call back function 400 is subsequently executed each time the retry timer 212 indicates that the status check interval has elapsed

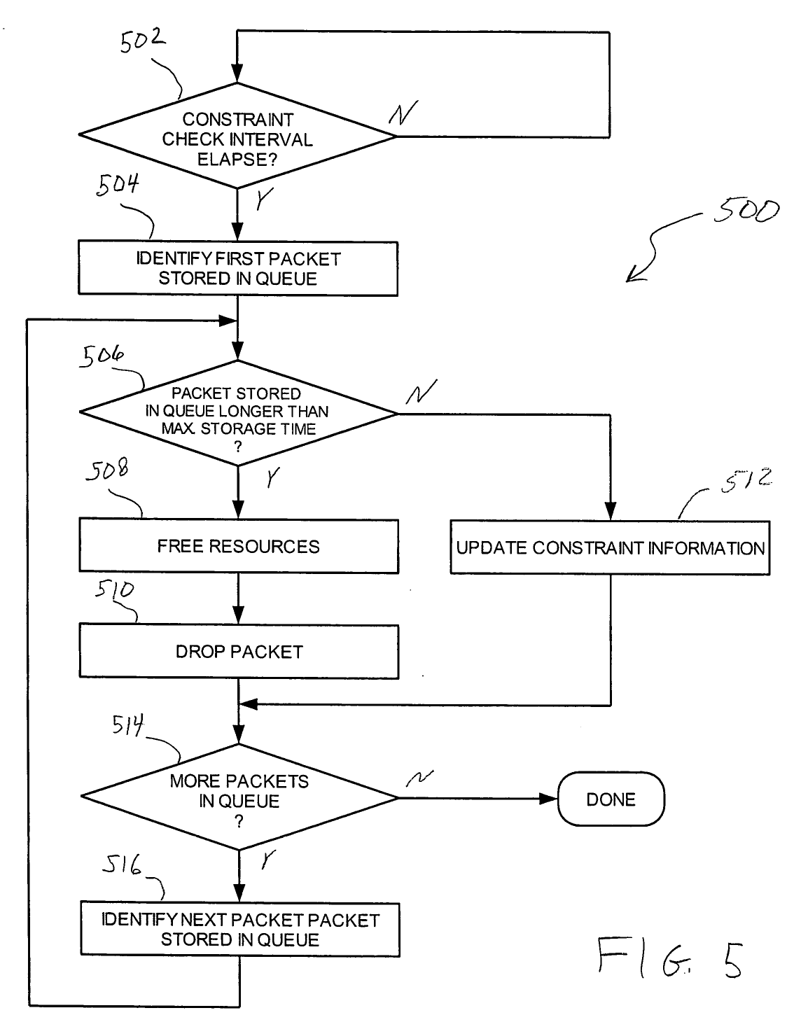

FIG. 5 is one embodiment of a method 500 of flushing packets from the queue 210. In the embodiment shown in FIG. 5, method 500 is executed by the IPSEC subsystem 204 after each time the constraint check interval elapses. When the retry timer 212 indicates that a constraint check interval has elapsed (checked in block 502), a first packet stored in the queue 210 is identified (block 504). If the first packet has been stored in the queue 210 longer than the maximum storage time (checked in block 506), then the resources associated with storing the first packet in the queue 210 are freed up (block 508) and then the packet is dropped (block 510).

Otherwise, the time constraint information for the packet is updated (block 512). For example, in one implementation, the time constraint information includes a counter that counts the number of constraint check intervals that have elapsed while the packet has been stored in the queue 210. The time constraint information is updated by incrementing the counter each time the constraint check interval elapses. In such an implementation, the maximum storage time is expressed as a number of constraint check intervals and when the counter equals (or exceeds) that number, the packet has been stored in the queue 210 longer than the maximum storage time and will be removed from the queue 210 the packet is checked.

If there is a next packet in the queue 210 (checked in block 514), then the next packet in the queue 210 is identified (block 516). Then the method 500 is repeated for that next packet. Otherwise, method 500 terminates when all the packets stored in queue 210 are checked. As shown in FIG. 5, the method 500 is subsequently executed each time the retry timer 212 indicates that the constraint check interval has elapsed

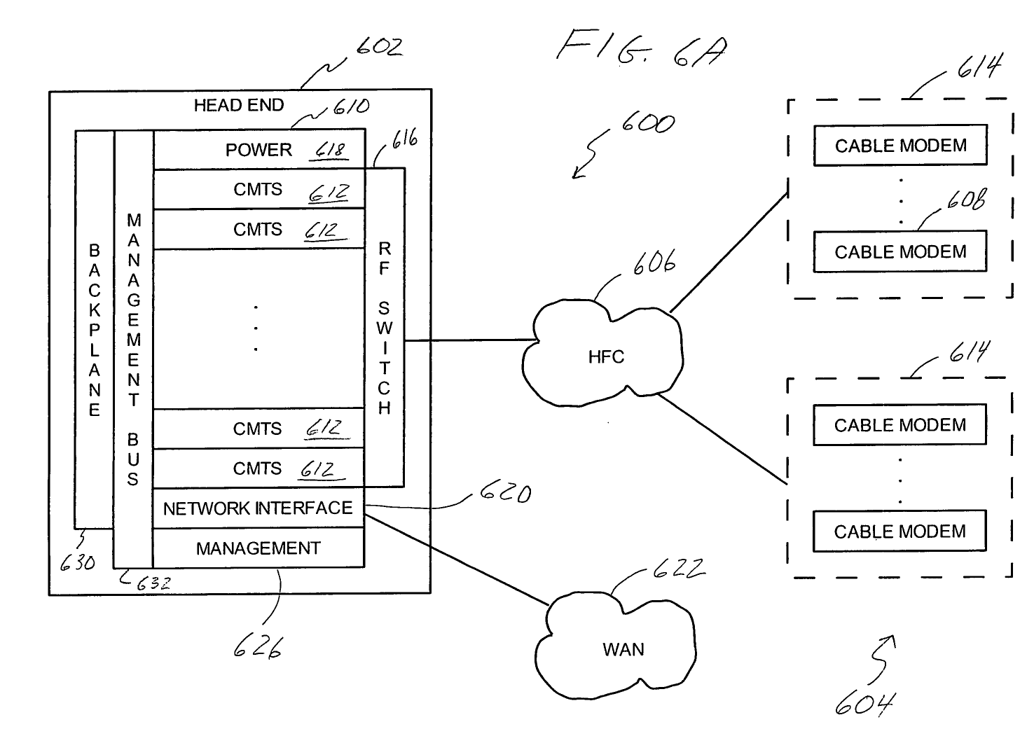

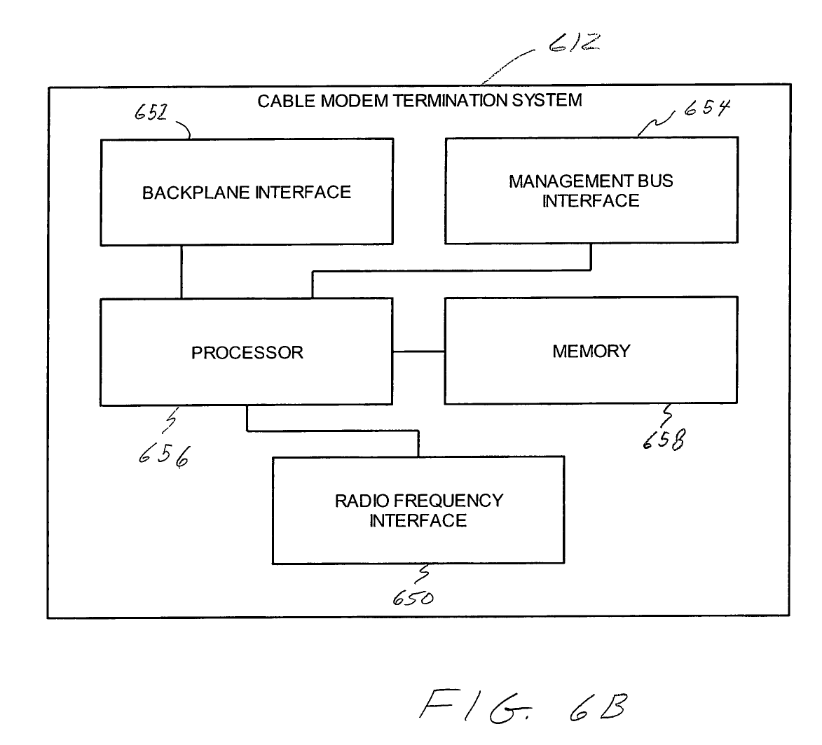

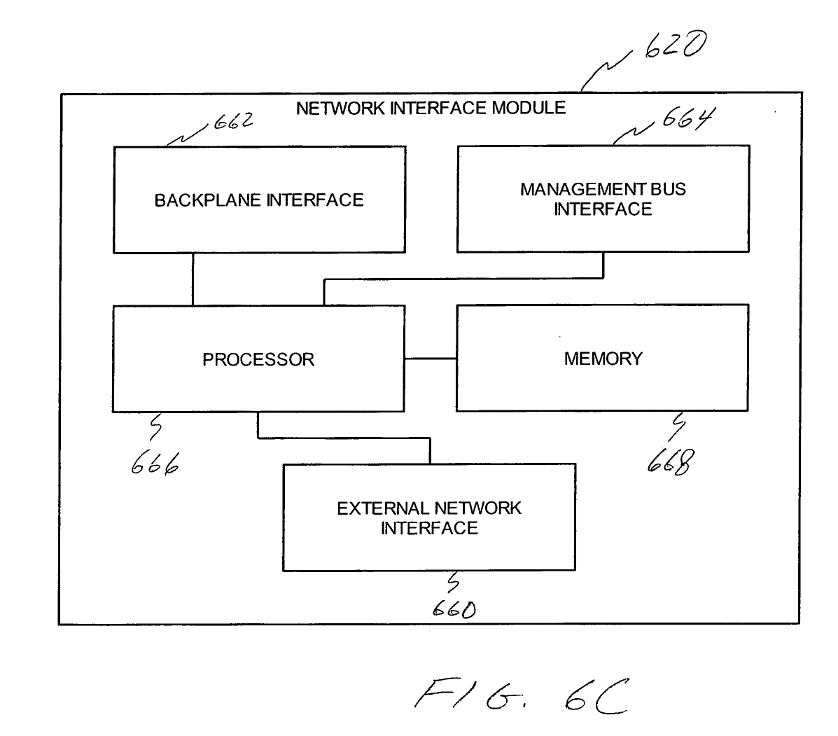

FIG. 6A is a block diagram of one embodiment of a cable system 600 in which embodiments described here are implemented. Cable system 600 includes a head end 602 that communicates with several items of customer premises equipment 604 using a hybrid fiber coax infrastructure 606. The customer premises equipment 604 includes, for example, a cable modem 608. The head end 602 includes an access switch 610. Access switch 610 typically includes a chassis that houses multiple cable modem termination systems 612. In one implementation, each cable modem termination system 612 is located on a blade that is inserted into the chassis of the access switch 610.

Each of the cable modem termination systems 612 is coupled to a separate group 614 of cable modems 608 over the hybrid fiber coax infrastructure 606 of the cable system 600. An RF switch 616 interfaces each of the cable modem termination systems 612 to the group 614 of cable modems 608 serviced by that CMTS 612. In one implementation of such an embodiment, the RF switch 616 is a part of the access switch 610.

The access switch 610 also includes one or more power supplies 618 that provide power to the various components of the access switch 610. The access switch 610 includes one or more network interface modules 620 that couple the access switch 610 to a network external to the access switch 610. In the embodiment shown in FIG. 6A, the network interface module 620 couples the access switch 610 to a wide area network (WAN) 622. For example, in one embodiment, WAN 622 includes a SONET ring coupling the access switch 610 to the Internet and a public switched telephone network. The cable modem termination systems 612 and the network interface modules 620 communicate with one another over a backplane 630. In one implementation of such an embodiment, the backplane 630 is implemented as a mesh backplane that provides a point-to-point bi-directional communication link between each CMTS 612 and network interface module 620 housed in the access switch 610.

The access switch 610 also includes a management module 626 that, in one embodiment, runs software that monitors and controls the operation of the access switch 610. The management module 626 communicates with the other modules housed in the access switch 610 over a management bus 632. In one implementation of such an embodiment, two redundant management modules 626 are housed in access switch 610, each of which communicates with the modules of access switch 610 over one of two redundant management buses 632.

FIG. 6B is a block diagram of one embodiment of a cable modem termination system 612 suitable for use in the cable system 600. Cable modem termination system 612 includes radio frequency (RF) interface 650 that couples that couples the CMTS 612 to the cable modems 608 (not shown in FIG. 6B) serviced by that CMTS 612.

The RF interface 650 couples the CMTS 612 to the cable modems 608 over a single downstream channel. For example, in a DOCSIS-based CMTS 612, the downstream channel is a 6 megahertz channel located in the frequency range of 50 megahertz to as high as 850 megahertz. The RF interface 650 converts downstream digital packets into modulated analog frames using quadrature amplitude modulation (for example, 64 QAM or 256 QAM), forward error correcting (FEC) code, and packet interleaving. The RF interface 650 upconverts the modulated analog frames into the downstream RF frequency range. The upconverted signal is then output to the RF switch 616 (not shown in FIG. 6B), which couples the electrical upconverted RF signal to an electrical-to-optical converter (not shown) that converts the electrical upconverted signal to an optical signal suitable for transmission on the HFC infrastructure 606 (not shown in FIG. 6B) to the cable modems 608.

The RF interface 650 also couples the CMTS to the cable modems 608 over multiple upstream channels. In exemplary implementations, four, six, or eight upstream channels are used. In one such implementation, the upstream channels are up to 6 megahertz wide (in the case of DOCSIS 2.0) and are located in the frequency range of 5 megahertz to 42 megahertz.

The RF interface 650 in the embodiment shown in FIG. 6B receives an upstream analog RF signal on each of the upstream channels. Each upstream analog RF signal is, for example, in the frequency range of 5 megahertz to 42 megahertz. In one implementation, the RF interface 650 services four, six, or eight upstream channels. The RF interface 650 amplifies, analog-to-digital converts, downconverts and demodulates the upstream analog RF signal for each of the upstream channels.

The CMTS 612 includes a backplane interface 652. The backplane interface 652 couples the CMTS 612 to the backplane 630 of the access switch 610. The backplane interface 652 sends packets to and receives packets from other modules housed with the access switch 610 via the backplane 630. For example, the backplane interface 652 provides an interface that couples the CMTS 612 to an upstream network (for example, the WAN 622) over the backplane 630 and the network interface module 620.

The CMTS 612 also includes a management bus interface 654 that is used couple CMTS 612 to the management bus 632. In embodiments of access switch 610 where two redundant management modules 626 and management buses 632 are provided, the CMTS 612 includes two management bus interfaces 654 for coupling the CMTS 612 to the two management buses 632.

The CMTS 612 also includes at least one processor 656 and at least one memory 658 coupled to the processor 656. Program instructions that are executed by the processor 656 are stored in memory 658. The program instructions, when executed by processor 656, cause the CMTS 612 to carry out all or a part of the functionality described herein in connection with FIGS. 1 through 5. Suitable data structures for implementing such functionality is stored in memory 658. Memory 658 is implemented using any suitable form of memory, including, for example, read only memory (ROM) and random access memory (RAM). In particular, the processor 656 overseas the routing and forwarding of packets from and to the RF interface 650, the backplane interface 652 and the management bus interfaces 654. Moreover, although a single processor 656 and a single memory 658 are shown in FIG. 6B, in other embodiments multiple processors 656 and/or multiple memories 658 are used. For example, in one such other embodiment, a separate network processor is provided to process internet protocol (IP) packets.

FIG. 6C is a block diagram of one embodiment of a network interface module 620 suitable for use in the cable system 600. The network interface module 620 includes an external network interface 660 that couples the network interface module 620 to an external network. For example, as shown in FIG. 6A, where the network interface module 620 couples the access switch 610 to a WAN 622, the external network interface 660 includes an interface suitable for coupling the network interface module 620 to the WAN 622. In one implementation, the external network interface 660 includes a SONET/SDH interface that can be used to couple the network interface module 620 to a SONET ring. In another implementation, the external network interface 660 includes an ETHERNET interface that can be used to couple the network interface module 620 an Ethernet network (for example, a 10/100 or gigabit WAN or LAN).

The network interface module 620 includes a backplane interface 662. The backplane interface 662 couples the network interface module 620 to the backplane 630 of the access switch 610. The backplane interface 662 sends packets to and receives packets from other modules housed with the access switch 610 via the backplane 630.

The network interface module 620 also includes a management bus interface 664 that is used couple network interface module 620 to the management bus 632. In embodiments of access switch 610 where two redundant management modules 626 and management buses 632 are provided, the network interface module 620 includes two management bus interfaces 664 for coupling the network interface module 620 to the two management buses 632.

The network interface module 620 also includes at least one processor 666 and at least one memory 668 coupled to the processor 666. Program instructions that are executed by the processor 666 are stored in memory 668. The program instructions, when executed by processor 666, cause the network interface module 620 to carry out all or a part of the functionality described herein in connection with FIGS. 1 through 5. Suitable data structures for implementing such functionality are stored in memory 668. Memory 668 is implemented using any suitable form of memory, including, for example, read only memory (ROM) and random access memory (RAM). In particular, the processor 666 overseas the routing and forwarding of packets from and to the external network interface 660, the backplane interface 662 and the management bus interfaces 664. Moreover, although a single processor 666 and a single memory 668 are shown in FIG. 6B, in other embodiments multiple processors 666 and/or multiple memories 668 are used. For example, in one such other embodiment, the network interface module 620 includes a separate processor is provided on which a route server executes.

The methods and techniques described here may be implemented in digital electronic circuitry, or with a programmable processor (for example, a special-purpose processor or a general-purpose processor such as a computer) firmware, software, or in combinations of them. Apparatus embodying these techniques may include appropriate input and output devices, a programmable processor, and a storage medium tangibly embodying program instructions for execution by the programmable processor. A process embodying these techniques may be performed by a programmable processor executing a program of instructions to perform desired functions by operating on input data and generating appropriate output. The techniques may advantageously be implemented in one or more programs that are executable on a programmable system including at least one programmable processor coupled to receive data and instructions from, and to transmit data and instructions to, a data storage system, at least one input device, and at least one output device. Generally, a processor will receive instructions and data from a read-only memory and/or a random access memory. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and DVD disks. Any of the foregoing may be supplemented by, or incorporated in, specially designed application-specific integrated circuits (ASICs).

A number of embodiments of the invention defined by the following claims have been described. Nevertheless, it will be understood that various modifications to the described embodiments may be made without departing from the spirit and scope of the claimed invention. Accordingly, other embodiments are within the scope of the following claims.

1. A method, comprising:
when a packet is to be sent over a secured connection, determining if the secured connection is set up;
when the secured connection is not set up, storing the packet; and
after storing the packet, when the secure connection is set up, retrieving the packet and transmitting the packet over the secured connection.

2. The method of claim 1, wherein the secured connection is an internet protocol security protocol connection.

3. The method of claim 1, wherein the secured connection is set up when a security association associated with the secured connection is set up.

4. The method of claim 1, wherein when the secured connection is not set up, setting up the secured connection.

5. The method of claim 4, wherein setting up the secured connection includes negotiating a security association associated with the secure connection.

6. The method of claim 5, wherein negotiation the security association includes negotiating the security association using the internet key exchange protocol.

7. A system, comprising:
a networking subsystem;
a security subsystem;
a negotiation subsystem; and
a packet store;
wherein when the networking subsystem generates a packet that is to be transmitted over a secure connection, the networking subsystem determines if the secure connection is set up;
when the secure connection is set up, the networking subsystem signals the negotiation subsystem to set up the secure connection and stores the packet in the packet store; and
after storing the packet, the security subsystem periodically determines whether the secure connection is set up and, when the security subsystem determines that the secure connection is set up, the packet is retrieved from the packet store and the security subsystem transforms the packet and transmits the packet over the secure connection.

8. The system of claim 7, wherein the networking subsystem stores the packet in a queue.

9. The system of claim 7, wherein the networking subsystem, before storing the packet, checks whether storing the packet would violate a constraint related to the storage of the packet.

10. The system of claim 9, wherein when the networking subsystem determines that storing the packet would violate a constraint related to the storage of the packet, the networking subsystem does not store the packet and wherein when the networking subsystem determines that storing the packet would not violate a constraint related to the storage of the packet, the networking subsystem stores the packet.

11. The system of claim 9, wherein the constraint related to the storage of the packet includes a maximum package storage time that specifies how long a packet is to be stored before being dropped.

12. The system of claim 9, wherein the constraint related to the storage of the packet includes a maximum packet limit that specifies the maximum number of packets that can be stored at one time.

13. The system of claim 9, wherein the constraint related to the storage of the packet includes a maximum amount of system memory for storage of packets.

14. The system of claim 7, further comprising a timer that determines when the security subsystem periodically determines whether the secure association exists for the internet protocol security protocol connection.

15. A system, comprising:
a networking subsystem;
an internet protocol security protocol subsystem;
an internet key exchange subsystem; and
a packet store;
wherein when the networking subsystem generates a packet that is to be transmitted over an internet protocol security protocol connection, the networking subsystem determines if a security association associated with the internet protocol security protocol connection exists;
when the security association does not exist, the networking subsystem signals the internet key exchange subsystem to negotiate the security association and stores the packet in the packet store; and
after storing the packet, the internet protocol security protocol subsystem periodically determines whether the security association exists for the internet protocol security protocol connection and, when the internet protocol security protocol subsystem determines that the security association exists for the internet protocol security protocol connection, the packet is retrieved from the packet store and the internet protocol security protocol subsystem transforms the packet and transmits the packet over the internet protocol security protocol connection in accordance with the internet protocol security protocol.

16. The system of claim 15, wherein the internet protocol security protocol subsystem determines whether the security association exists for the internet protocol security protocol connection after successive periodic intervals elapse.

17. The system of claim 16, wherein each periodic interval is 500 milliseconds long.

18. A programmable-processor readable medium on which program instructions are stored, wherein the program instructions are operable to cause a programmable processor to:
when a packet is to be sent over a secured connection, determine if the secured connection is set up;
when the secured connection is not set up, store the packet; and
after storing the packet, when the secure connection is set up, retrieve the packet and transmitting the packet over the secured connection.

19. A cable modem termination system, comprising:
a radio frequency interface that, when the cable modem termination system is coupled to a hybrid-fiber coaxial cable network, communicates with the hybrid-fiber coaxial cable network;
an second interface that, when the cable modem termination system is coupled to an upstream network, communicates with the upstream network;
a programmable processor coupled to the radio frequency interface and the second interface; and
memory coupled to the programmable processor, wherein program instructions are stored in the memory that, when executed on the programmable processor, cause the cable modem termination system to:
when a packet is to be sent over an internet protocol security protocol connection, determine if a security association associated with the internet protocol security protocol connection exists;
when the security association does not exist, store the packet in a packet store; and
after the packet is stored, periodically determine whether the security association exists for the internet protocol security protocol connection and, when the security association exists for the internet protocol security protocol connection, retrieve the packet from the packet store and transmit the packet over the internet protocol security protocol connection.

20. The cable modem termination system of claim 19, wherein the program instructions, when executed by the programmable processor, cause the cable modem termination system to, when the packet is to be sent over the internet protocol security protocol connection and the security association does not exist, negotiate with a destination node for which the packet is intended to set up the security association.

21. The cable modem termination system of claim 19, wherein the second interface includes a backplane interface of an access switch that, when the cable modem termination system is coupled to a backplane, communicates with the backplane.

22. The cable modem termination system of claim 21, wherein the second interface communicates with the upstream network over the backplane.

23. The cable modem termination system of claim 21, wherein the second interface communicates with a second cable modem termination system over the backplane.

24. A network interface module, comprising:
an external network interface that, when the network interface module is coupled to an external network, couples the network interface module to the external network;
a backplane interface that, when the network interface module is coupled to a backplane, communicates with the backplane;
a programmable processor coupled to the external network interface and the backplane interface; and
memory coupled to the programmable processor, wherein program instructions are stored in the memory that, when executed on the programmable processor, cause the network interface module to:
when a packet is to be sent over an internet protocol security protocol connection, determine if a security association associated with the internet protocol security protocol connection exists;
when the security association does not exist, store the packet in a packet store; and
after the packet is stored, periodically determine whether the security association exists for the internet protocol security protocol connection and, when the security association exists for the internet protocol security protocol connection, retrieve the packet from the packet store and transmit the packet over the internet protocol security protocol connection.

25. The network interface module of claim 24, wherein the program instructions, when executed by the programmable processor, cause the network interface module to, when the packet is to be sent over the internet protocol security protocol connection and the security association does not exist, negotiate with a destination node for which the packet is intended to set up the security association.

26. The network interface module of claim 25, wherein the program instructions, when executed by the programmable processor, cause the network interface module to, when the packet is to be sent over the internet protocol security protocol connection and the security association does not exist, negotiate with the destination node for which the packet is intended to set up the security association using an internet key exchange protocol.

27. The network interface module of claim 24, wherein the external network includes a wide area network.

28. The network interface module of claim 27, wherein the wide area network includes the Internet.
